(19) United States
(12) Patent Application Publication
(10) Pub. No.: US 2010/0194153 A1
(43) Pub. Date: Aug. 5, 2010

(54) COVER FOR HATCH OPENING

(76) Inventor: Jerzy SZYJKOWSKI, Barrie (CA)

Correspondence Address: YOUNG BASILE, 3001 WEST BIG BEAVER ROAD, SUITE 624, TROY, MI, 48084, US

(21) Appl. No.: 12/700,012

(22) Filed: Feb. 4, 2010

Related U.S. Application Data
(60) Provisional application No. 61/206,659, filed on Feb. 4, 2009.

(51) Int. Cl. B60J 7/047

(52) U.S. Cl. 296/216.03

(57) ABSTRACT

A multipurpose device useable as a cover for a hatch opening in recreational vehicles and vessels. The device includes several panels connected together and adjustable straps for removable attachment to a resident hatch or closure panel. When installed on a fully or partially open hatch, the device is useful to increase ventilation and reduce the entrance of rain or water passing through the hatch opening. The device is multiform and multipurpose and can be used for alternate recreational activities when not installed as a hatch opening cover.

This application claims priority on the basis of previously filed U.S. Provisional Patent Application No. 61/206,659 filed Feb. 4, 2009.

This invention relates to covers or hoods for hatch openings of a vessel or vehicle.

### BACKGROUND OF THE INVENTION

Many recreational vessels have on board sleeping accommodations or cabins equipped with hatches which can be opened or closed with hatch covers which are usually secured to the vessel. Such hatches can provide light, ventilation and a means of escape in case of an emergency. However a hatch or hatch opening can give rise to one significant inconvenience or difficulty that can arise in rainy or stormy weather. Hatches are normally installed horizontally or substantially horizontally so that if a particular hatch is open when it is raining, the rain water can enter the inside of the cabin or vessel through the hatch opening. This problem is alleviated, of course, if the hatch is equipped with a standard hatch cover which can be rectangular or circular, depending on the shape of the opening, provided of course that the hatch cover is properly closed before it starts to rain. However, if the vessel owner is away from the vessel for a period of time, he or she may not be around to close the hatch in time to prevent rain from entering into the cabin and potentially damaging the cabin interior.

Another possible difficulty with known hatches is that because they are relatively small in size, they may not provide much ventilation, particularly if they are only partially open or cannot be opened fully to completely uncover the hatch opening. In particular, even if there is a slight breeze, the relatively small hatch cover may not direct much fresh air into the cabin or into the interior of the vessel.

U.S. Pat. No. 5,022,339 issued June 1991 to Kermit Baskin discloses a ventilator for attachment to a deck hatch. This ventilator has a top panel which can abut an open cover of the deck hatch so that it slopes upwardly from the deck. First and second triangular side panels extend downwardly from the side edges of the top panel to the deck and there is also an outer front panel extending downwardly from the upper edge of the top panel, to a lower edge spaced from the deck. The ventilator further includes an inner front panel that extends upwardly from the deck but is sloped inwardly. This ventilator is said to prevent rain from passing into the boat through the hatch opening. The panels are fabricated of waterproof cloth and the top and outer front panels are formed with pouches that receive rigid plates. This ventilator is attached to the deck surface around the hatch by means of a bead of welting stitched to the lower edges of the panels and hold down tracks on the deck.

Despite the known hatch covers for hatch openings and the aforementioned known ventilator that can be attached directly to the deck, there is a need for an improved device that can be used as a cover for a hatch opening. In particular, there is need for such a device that is reasonably inexpensive and that is easy to use.

### SUMMARY OF THE INVENTION

According to one embodiment of the present disclosure, an inflatable device usable as a cover for a hatch opening includes inflatable first and second panels, each having four side edges, these panels being connected to one another along adjacent side edges thereof. The device also has two inflatable, triangular side panels each having three side edges with one side edge of each side panel being connected to a respective one of the side edges of the first panel. Another of the side edges of each side panel is connected to a respective one of the side edges of the second panel. There are also connecting straps attached to the combination of the first, second and side panels and adapted to secure the inflatable device to a hatch cover for the hatch opening when the hatch cover is raised.

In an exemplary version of this inflatable device, each of the first and second panels are rectangular and the connecting straps comprise two pairs of strap members, which one strap member of each pair connected to the combination at a first of the side edges of the first panel and the second strap member of each pair connected to the combination at a second of the side edges of the first panel opposite the first side edge.

In a particular exemplary embodiment, when all of the panels are inflated, the first panel extends at an obtuse angle relative to the second panel. This obtuse angle arrangement can be advantageous when the inflatable device is being used as a wind catching hood for enhanced cabin ventilation as explained further hereinafter.

According to a second embodiment of the present disclosure, a cover for a hatch opening of a vehicle or vessel includes rectangular first and second panels, each having an inner side edge, an opposite outer side edge and two connecting side edges extending between the inner and outer side edges. The inner side edges of these two panels are connected together. The cover also has two triangular side panels each having first, second and third side edges. The first side edge of each side panel extends along and is connected to a respective one of the connecting side edges of the first panel. The second side edge of each side panel extends along and is connected to a respective one of the connecting side edges of the second panel. There are also two connecting strap devices attached to the cover at or near the connecting side edges of one of the first and second panels and adapted to secure the cover to a regular hatch cover for the hatch opening, which is attached to the vehicle or vessel and is raised to a partially open or open position. One of the connecting strap devices attached close to or at the inner side edge of one of the first and second panels and the other connecting strap device is spaced from the one connecting strap device attached close to or at the outer side edge of the one first or second panel.

In an exemplary version of this cover, each connecting strap device includes a buckled mechanism and two strap members each connected at one end to the cover at or near a respective one of the connecting side edges. The buckle mechanism is capable of detachably connecting the two strap members together.

According to another embodiment of the present disclosure, a detachable device usable as a cover for a hatch opening of a vessel or vehicle includes first and second panels which are connected to one another along adjacent inner side edges of the panels. The panels each have an outer side edge spaced from its respective inner side edge and connecting side edges extending between the inner and outer side edges. Two inflatable triangular side panels each have first, second and third side edges. The first side edge of each side panel extending along and being connected to a respective one of the connecting side edges of the first panel and the second side edge of each side panel extending along and being connected to a respective one of the connecting side edges of the second panel. The device further includes connecting straps attached to the combination comprising the first, second and side panels and adapted for detachably securing the device to a hatch cover for the hatch opening when the hatch cover is raised. This device can be at least partially collapsed by deflating the side panels.

In an exemplary version of this device, the first and second panels are also inflatable and the device can be further collapsed by deflating the first and second panels as well as the side panels.

These and other aspects of the disclosed devices and covers will become more readily apparent to those having ordinary skill in the art from the following detailed description taken in conjunction with the accompanying drawings.

### BRIEF DESCRIPTION OF THE DRAWINGS

So that those having ordinary skill in the art to which the present disclosure pertains will more readily understand how to make and use the subject invention, exemplary embodiments thereof will be described in detail herein below with reference to the drawings, wherein:

FIG. 1 is a perspective view of one embodiment of the present disclosure, this view being taken from one side;

FIG. 2 is a side view of the cover of FIG. 1, this view being taken in the direction of the arrow A shown in FIG. 1;

FIG. 3 is a side view similar to FIG. 2 but showing the cover attached to a regular cover that has been raised to a vertical position;

FIG. 4 is another side view of the cover of FIG. 1, this view being taken from the left side of FIG. 3 with the cover being partially broken away for purposes of illustration and with the cover being shown above a hatch opening;

FIG. 5 is a schematic side view similar to FIG. 4 but showing the cover of FIG. 1 attached to the hatch cover which is in a half opened position which allows passage of outside air through the hatch opening and into a cabin below the opening;

FIG. 6 is a schematic side view showing schematically an embodiment of the present cover with an optional cushion panel connected to one edge of the cover;

FIG. 7 is a detail view showing a series of snap connectors for joining the optional cushion panel to the edge of the cover; and

FIG. 8 is another detail view showing a zipper connecting the optional cushion panel to the edge of the cover.

### DESCRIPTION OF THE PREFERRED EMBODIMENT

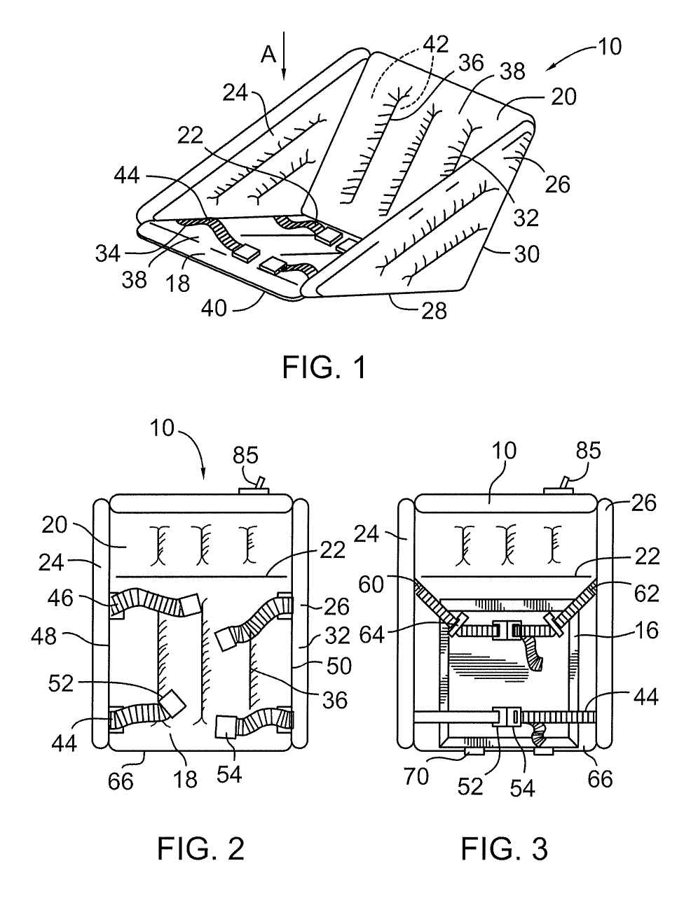

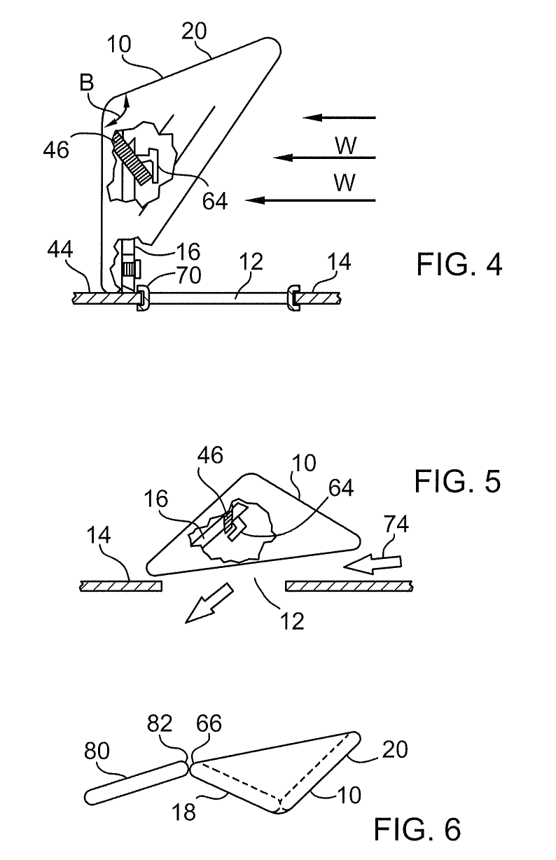

With reference to FIGS. 1 and 2, there is shown therein an inflatable device or cover 10 usable as a cover for a hatch opening such as the hatch opening 12 shown in FIG. 4. This opening can, for example, be formed in a deck 14 or a superstructure of a vessel, and, in particular, a marine vessel such as a boat or ship. Normally the opening extends horizontally or substantially horizontally and it can be used to allow sunlight or fresh air to enter into a cabin or below deck area. Normally, a regular hatch cover 16 is pivotably attached to the deck or superstructure adjacent the opening and can be used to close the hatch opening when required. The exemplary device 10 has a first panel 18 and a second panel 20, both of the illustrated panels being inflatable by means of at least one air valve. An air valve 85 on the outside of the second panel is shown in FIG. 2. The illustrated panels are rectangular or square, with each having four side edges. The first and second panels are connected together along adjacent side edges thereof which can be referred to as inner edges located at 22. The device 10 also has two inflatable triangular side panels 24 and 26. Thus, each side panel has three side edges including a first side edge 28, a second side edge 30 and a longer, third side edge 32. The first side edge of each side panel, 24, 26, is connected to a respective one of the side edges of the first panel 18 (for example, by a heat seal or by suitably sewn joint) and the second side edge 30 of each side panel is connected to a respective one of the side edges of the second panel 20. In addition, this inflatable device has connecting straps indicated generally by reference 34 attached to the combination of the first, second and side panels and adapted to secure the inflatable device to the hatch cover 16 for the hatch opening when the hatch cover is raised. The manner in which the device can be attached to the hatch cover 16 is illustrated in FIGS. 3 and 4 where the hatch cover is shown in a vertical, raised position.

In an exemplary version of the device, the first and second panels 18, 20 are rectangular and each is constructed with a plurality of straight seams 36 which can be formed in a known manner by heat sealing. It will be appreciated that each panel, when constructed to be inflatable, is made of inner and outer air impervious sheets indicated at 38 and 40, with these sheets being joined together about their outer perimeter in a sealing manner. The elongate seams 36 formed in the sheets form elongate air passageways 42 which can be interconnected in order to allow air to flow between the passageways. Thus, with the provision of one air valve in the side of one of the panels, air under pressure can be introduced into and can inflate all of the panels. Alternatively, more than one air valve can be provided in order to inflate all of the panels. In one exemplary version of the cover, an air valve is provided for each inflatable panel.

In an exemplary version of the device, when all of the panels are inflated, the first panel 18 which is substantially planar, extends at an obtuse angle to the substantially planar second panel 20. An exemplary obtuse angle is shown in FIG. 4 and is indicated at B. In an exemplary embodiment, the obtuse angle can range between 120 and 145 degrees.

It will be appreciated that the device 10 can be used for purposes other than as a cover for a hatch opening. In particular, the device 10 can be used as a comfortable seat for a person to sit on. Thus, an exemplary version of the device 10 is made sufficiently large so that it not only serves as a cover for a hatch opening but can also serve as a seat for a person. When the device is being used as a seating device, the first panel 18 can provide a seat cushion while the second panel 20 provides a back support cushion that is connected to the seat cushion by means of the side panels. It will be understood that the size of the first and second panels can vary, but generally these panels or cushions are made large enough to accommodate most sizes of hatch tops or hatch covers 16 found on pleasure craft and other vessels or vehicles. If the device or covering 10 is constructed to serve also as possible seating, then the first and second panels are made in a manner that will provide comfortable seating. For example, the first panel 18 is constructed so as to provide a comfortable cushion for a person to sit on. It will be appreciated by those skilled in the art that the thickness of all of the cushions and the panels or fabrics from which they are made must be sufficient for the construction and materials employed. In one exemplary version of the device 10, the inflatable first and second panels 18 and 20 are similar in their thickness to the common, well known inflatable mattress that can be used by a person to lay down on or to float on.

Returning to the connecting straps 34, in an exemplary version of the device, there are two pairs of strap members at 44 and 46. One strap member of each pair is connected to the combination of panels at a first of the side edges of the first panel, this side edge being indicated at 48. The second strap member of each pair is connected to the combination of panels at a second side edge 50 of the first panel opposite the side edge 48. The strap members, which are elongate, are each provided with part of a buckle mechanism. It will be understood that the buckle parts 52, 54 can be detachably connected together (as shown in FIG. 3) to secure the inflatable device 10 to the hatch cover 16. Each buckle mechanism can be of standard construction and can be similar, for example, to the buckles used in well known personal flotation devices.

FIGS. 3 and 4 illustrate the device or cover 10 mounted on a hatch cover 16 that has been raised to a vertical position. It will be seen that the strap members are positioned to facilitate the attachment of the cover 10 to the hatch cover. In particular, the pair of strap members 46 are connected to the opposite side edges of the first panel 18 at locations 60, 62 which are adjacent the inner edges 22 of the first and second panels. This location allows this pair of strap members to be connected to the elevated top portion of the hatch cover and, in particular, with some hatch covers, the strap members can extend around hatch panel locking hardware indicated at 64. Furthermore, the second pair of strap members 44 are connected to the two opposite side edges of the first panel 18 at locations adjacent the first outer side edge 66 of this panel. Also shown in FIGS. 3 and 4 are two hatch cover hinges 70 that pivotably connect the hatch cover to the deck 14. It will be seen that the first panel extends parallel to the raised hatch cover 16 and the second panel 20 extends upwardly at an angle to the horizontal and extends at least a substantial distance over the opening 12. In this position, the cover 10 together with the regular hatch cover 16 can promote improved or accelerated ventilation of a cabin located below the opening 12. If the wind direction is the direction indicated by the arrows W or is even close to this direction, the wind will be directed down through the hatch opening. Thus, the ventilation provided by the addition of the cover 10 is enhanced and is better than would be provided by the raised cover 16 alone.

The two pairs of strap members 44, 46 as shown in FIGS. 3 and 4 extend over the inner surface of the hatch cover 16. In other words, they extend over the side of the hatch cover which is opposite the side covered by the inflated panel 18. The two strap members 44 and their buckle mechanism are close to the two hinges 70 for the cover 16.

The aforementioned hatch closures 64 can be in the form of clamps and it will be seen that these closures or locks are located lower than the location 60, 62 to which the strap members 64 are attached to the cover 10. It will be understood that after the cover 10 has been placed in position on the hatch cover 16, tension is applied by pulling on the loose ends of the straps 44, 46, thereby assuring that the cover 10 is snugly fitted to the cover 16. If the strap members are initially too long for a secure fit, they can be pulled through at least one part of the buckle mechanism to provide the final adjustment and snug fit. When the hatch cover 16 is fitted with the locking hardware 64 as shown or similar locks, a snug or firm installation can be assured as the two upper strap members 46 attached by their buckle mechanism can be used to apply downward tension on the cover 10. With this downward tension applied, the cover 10 can only move downwards to the point where the outer edge of the first panel 18 comes into contact with the deck 14 (the position shown in FIG. 4). When the cover is in this position, it will be firmly held in this position by the upper strap members 46 and the lower strap members 44 and their respective buckles. The cover 10 can readily be removed from the hatch cover 16 by disconnecting each buckle mechanism.

FIG. 5 illustrates an alternate position of the cover 10 while connected to the hatch cover 16. In this partially closed position, the cover 10 and the cover 16 still allow for some ventilation of the cabin below and will disallow or substantially prevent entry of rain water through the opening 12. The possible air flow for ventilation is indicated by the arrows 74.

FIG. 6 is a schematic view of the cover 10 to which has been attached an additional panel 80 which, in this exemplary embodiment, is rectangular with four side edges. The illustrated panel is in the form of an inflated cushion with its own separate air chamber and air valve (not shown). Thus, the panel 80 can be inflated or deflated separately from the device 10 for greater convenience. One of the side edges indicated at 82 of the optional panel is connected to the outer side edge 66 of the device 10 located furthest from the second panel 20. The panel 80 is connected in such a manner that it can pivot relative to the first panel 18 at its one connected edge. A variety of fasteners of known construction can be used to detachably connect the optional panel 80.

FIG. 7 illustrates how the panel 80 can be attached to the outer edge of the first panel 18 by means of snap fasteners 100 which per se are of standard construction. The panel 80 can be provided with a flexible fastener strip 102 along which are secured a series of snap fastener halves. Similarly the first panel 18 can be provided with a flexible fastener strip 104 to which a series of cooperating snap fastener halves 106 can be secured. A heat seal can be formed between each of the fastener strips 102, 104 and its respective panel.

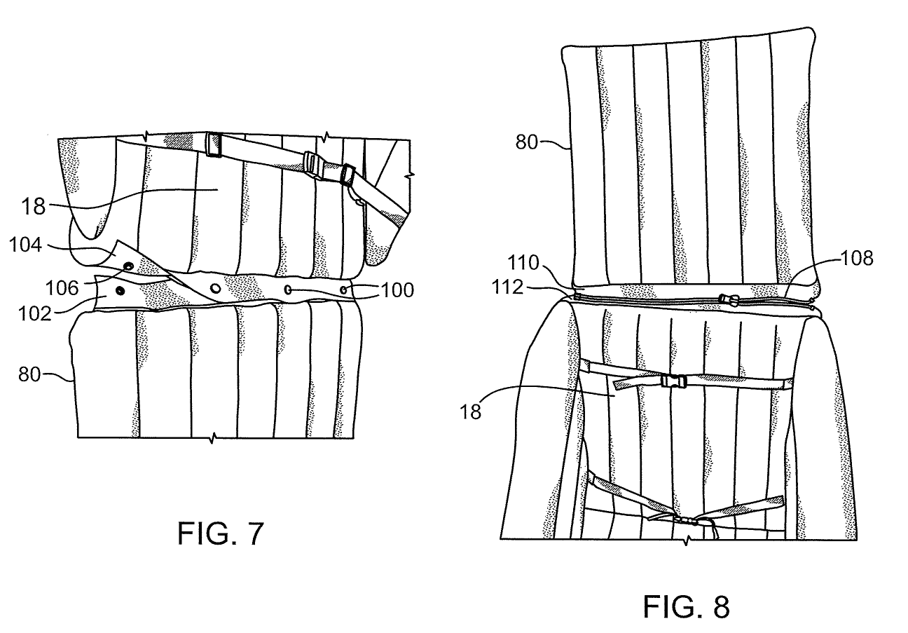

FIG. 8 illustrates how the panel 80 can be attached by means of a zipper 108 to the outer edge of the first panel 18. The zipper itself can be of standard construction and can have a length equal to about the width of the panel 80. An elongate flexible strip 110 can be formed along the edge of the panel 80 by means of a heat seal and one half of the zipper is attached to this strip. Similarly an elongate strip 112 is formed along the outer edge of the first panel 18 to which the other half of the zipper can be attached.

VELCRO™ strips can also be used, these strips consisting of strips of small loops and hooks that easily and firmly connect together.

It will be seen from the above description of the device or cover 10 that an exemplary version of this device can serve a variety of functions. In addition to functioning as a wind catching hood for enhanced cabin ventilation on a vessel and a hood that can prevent rain from entering through an open or partially open hatch on a vessel or vehicle. In particular, the device 10 can also serve as a cockpit or deck seat, a shore or beach chair, or a floating chair for use in water, particularly the inflatable version of the device.

As can be seen from FIGS. 1 and 2, the exemplary device 10 has substantially the shape of an arm chair with no legs. If the first and second panels 18 and 20 are constructed so as to have a substantially square shape as illustrated and extend relative to each other at a slightly open or obtuse angle, the device 10 can provide a reasonably comfortable seat for a person. As indicated, the device 10 can be made either inflatable with a construction similar to that of a standard air mattress in this respect, or its exterior can be made of a suitable waterproof fabric forming interior chambers or cavities that are filled with a suitable, lightweight plastics foam. The latter version will readily float in water if the device should fall into or be placed in water.

As indicated and as illustrated in FIG. 5, if the standard hatch cover 16 is opened about half way (for example, so that it extends at about a 45 degree angle to horizontal), the device 10 when attached to the hatch cover will enable fresh air to enter the cabin through the hatch opening while at the same time preventing rain water from entering the cabin.

The above described additional panel or cushion 80 is particularly useful when the device 10 is being used as a seat, in which case the additional panel can serve as a leg rest. The additional panel is also useful to support the legs of a user when the device 10 is used as a floating water chair.

It will be understood that the device 10 is not suited for use in extreme weather conditions, particular weather conditions involving strong winds. In such extreme conditions, the projection of the cover 10 over the hatch opening may not be or will not be sufficient to stop rain from entering into the interior of the vessel or cabin.

The aforementioned buckle sections 52, 54 can provide a quick release buckle mechanism for the attaching straps. At the opposite end of each of the strap members, the strap member can be secured by sewing in a manner that does not create holes that would prevent the inflation of the adjacent panels.

Because the additional panel 80 can be detached from the device 10, the panel in a detached state can be placed under the device 10, for example, under a horizontally arranged first panel 18 to make the chair formed by the device higher. This can render the device 10 more comfortable as a seat in some circumstances.

An exemplary form of material for use in the construction of the inflatable panels is a known rubberized fabric material, such as the material used in the construction of known inflatable mattresses.

It will be appreciated that an important advantage of the device 10 when it is constructed in whole or in part of inflatable panels is that the inflatable panels can be deflated for easy and convenient storage of the device. This can be important when the device needs to be stored in a boat or vessel or in a recreational vehicle where the storage space can be quite limited. It will be further appreciated that it is possible to construct the cover or device 10 with only some of the panels being inflatable. For example, in one alternate version, the first and second panels 18 and 20 can be simply panels filled with a light weight foam material with only the side panels 24, 26 being inflatable by means of suitable air valves. With this construction, once the side panels are deflated, the device 10 can still be made compact for storage by folding the second panel down on top of the first panel or vice versa. In a further alternative construction, the two triangular side panels can be filled with a light weight plastics foam material and only the two panels 18 and 20 are constructed as inflatable panels. With this construction, once the first and second panels 18 and 20 have been deflated, the device 10 can again be collapsed with the one side panel being placed against the other side panel as the first and second panels are folded.

A possible location for one air valve 85 is illustrated in FIGS. 2 and 3 but other locations are possible and, of course, a plurality of air valves can be provided if desired. Each air valve allows air to be blown into or to escape from the panel to which the air valve is connected and possibly additional panels if the panels are connected by air passageways.

While the present invention has been illustrated and described as embodied in exemplary embodiments, e.g., embodiments have particular utility as a cover or hood for a hatch opening, it is to be understood that the present invention is not limited to the details shown herein, since it will be understood that various omissions, modifications, substitutions and changes in the forms and details of the disclosed devices and covers may be made by those skilled in the art without departing in any way from the spirit and scope of the present invention. For example, those of ordinary skill in the art will readily adapt the present disclosure for various other applications without departing from the scope of the present invention.

We claim:

1. An inflatable device usable as a cover for a hatch opening, said device comprising:
inflatable first and second inflatable panels each having four side edges, said panels being connected to one another along adjacent side edges thereof;
two inflatable, triangular side panels each having three side edges, one of said side edges of each side panel being connected to a respective one of the side edges of the first panel and another of said side edges of each side panel being connected to a respective one of the side edges of the second panel, and
connecting straps attached to the combination of said first, second side panels and adapted to secure said inflatable device to a hatch cover for said hatch opening when said hatch cover is raised.

2. An inflatable device according to claim 1 wherein each of said first and second panels are rectangular and said connecting straps comprise two pairs of strap members with one strap member of each pair connected to said combination at a first of said side edges of the first panel and the second strap member of each pair connected to said combination at a second of said side edges of the first panel opposite said first side edge.

3. An inflatable device according to claim 1 wherein, when all of the panels are inflated, said first panel extends at an obtuse angle relative to said second panel.

4. An inflatable device according to claim 1 wherein said connecting straps comprise two pairs of elongate strap members each having part of a buckle attached thereto and wherein the buckle parts of each pair can be detachably connected together to secure the inflatable device to the hatch cover.

5. An inflatable device according to claim 1 including an additional panel having four side edges, one of which is connected to the side edge of the first panel located furthest from the second panel, wherein said additional panel can pivot relative to the first panel at its one connected edge.

6. An inflatable device according to claim 2 wherein each of said panels is made of a rubberized fabric material and at least one of said panels is provided with an air valve which allows air to be blown into or escape from said at least one panel.

7. An inflatable device according to claim 1 wherein said first and second panels are rectangular, said side edges of said first panel include a first inner side edge connected to the second panel and a first outer side edge parallel to and spaced from said inner side edge, said side edges of said second panel include a second inner side edge connected to said first panel and a second outer side edge parallel to and spaced from said second inner side edge, and a third side edge of each side panel extends substantially between the outer side edges of the first and second panels.

8. An inflatable device according to claim 7 wherein said connecting straps comprise first and second pairs of strap members, said first pair is connected to two opposite side edges of the first panel at locations adjacent said second inner side edge of the second panel, and said second pair is connected to said two opposite side edges of the first panel at locations adjacent said first outer side edge.

9. A cover for a hatch opening of a vehicle or vessel, said cover comprising:
rectangular first and second panels each having an inner side edge, an opposite outer side edge, and two connecting side edges extending between the inner and outer side edges, the inner side edges of the two panels being connected together;
two triangular side panels each having first, second and third side edges, the first side edge of each side panel extending along and connected to a respective one of said connecting side edges of the first panel, the second side edge of each side panel extending along and connected to a respective one of said connecting side edges of the second panel; and
two connecting strap devices attached to the cover at or near said connecting side edges of one of said first and second panels and adapted to secure said cover to a hatch cover for said hatch opening which is attached to the vehicle or vessel and is raised to a partially open or open position, wherein one of said connecting strap devices is attached close to or at the inner side edge of said one of the first and second panels and the other connecting strap device is spaced from said one connecting strap device and attached close to or at the outer side edge of said one of the first and second panels.

10. A cover according to claim 9 wherein each connecting strap device includes a buckle mechanism and two strap members each connected at one end to the cover at or near a respective one of the connecting side edges of the first panel, said buckle mechanism being capable of detachably connecting the two strap members together.

11. A cover according to claim 9 wherein said two side panels are flexible, inflatable panels.

12. A cover according to claim 9 wherein said first and second panels are flexible, inflatable panels.

13. A cover according to claim 9 wherein during use of said cover, the first and second panels are substantially planar and extend at an obtuse angle relative to each other.

14. A cover according to claim 9 wherein at least some of the panels are each constructed with a fabric exterior that covers a lightweight plastics foam panel interior whereby said cover is capable of floating on water.

15. A cover according to claim 9 including an additional rectangular panel having one side connectible to the outer side edge of said one of the first and second panels, said additional rectangular panel being pivotable relative to the first or second panel when connected thereto.

16. A detachable device usable as a cover for a hatch opening of a vessel or vehicle, said device comprising:
first and second panels which are connected to one another along adjacent inner side edges of the panels, said panels each having an outer side edge spaced from its respective inner side edge and connecting side edges extending between the inner and outer side edges;
two inflatable, triangular side panels each with first, second and third side edges, the first side edge of each side panel extending along and being connected to a respective one of the connecting side edges of the first panel and the second side edge of each side panel extending along and being connected to a respective one of the connecting side edges of the second panel; and
connecting straps attached to the combination comprising said first, second and side panels and adapted for detachably securing the device to a hatch cover for said hatch opening when said hatch cover is raised;
wherein said device can be at least partially collapsed by deflating said side panels.

17. A device according to claim 16 wherein said first and second panels are also inflatable and said device can be further collapsed by deflating said first and second panels as well as said side panels.

18. A device according to claim 16 wherein said connecting straps include two pairs of strap members, each pair is equipped with a buckle mechanism, and the strap members of each pair are connected to said first panel at its two connecting side edges and are spaced apart from the strap members of the other pair.

19. A device according to claim 16 wherein, when said side panels are inflated, said first and second panels extend at an obtuse angle to one another.

20. A device according to claim 19 including an additional inflatable panel having a side edge detachably connectible to the outer side edge of the first panel.
